(19) United States
(12) Patent Application Publication
(10) Pub. No.: US 2013/0314643 A1
(43) Pub. Date: Nov. 28, 2013

(54) DISPLAY DEVICE HAVING ENHANCED VISIBILITY AND MOBILE TERMINAL USING THE SAME

(71) Applicant: SAMSUNG ELECTRONICS CO. LTD., Suwon-si (KR)

(72) Inventor: Dongseop LEE, Seoul (KR)

(73) Assignee: Samsung Electronics Co. Ltd., Suwon-si (KR)

(21) Appl. No.: 13/891,662

(22) Filed: May 10, 2013

(30) Foreign Application Priority Data
May 25, 2012 (KR) 10-2012-0055860

(51) Int. Cl. G02F 1/1335

(52) U.S. Cl. CPC G02F 1/133504
USPC 349/62

(57) ABSTRACT

A display device having enhanced visibility and a mobile terminal including the same are provided. The display device includes a liquid crystal display panel for displaying a predetermined image by selectively transmitting incident light, a backlight unit for providing light for driving the liquid crystal display panel, a diffraction sheet disposed between the liquid crystal display panel and the backlight unit to diffract light from an external light source passing through the liquid crystal display panel and to reapply the light toward a front surface direction from a rear surface of the liquid crystal display panel.

### PRIORITY

This application claims the benefit under 35 U.S.C. §119(a) of a Korean patent application filed on May 25, 2012 in the Korean Intellectual Property Office and assigned Serial No. 10-2012-0055860, the entire disclosure of which is hereby incorporated by reference.

### BACKGROUND OF THE INVENTION

1. Field of the Invention

The present invention relates to a display device. More particularly, the present invention relates to a display device that can enhance visibility through angle adjustment of a terminal and a mobile terminal using the same.

2. Description of the Related Art

Mobile terminals have been spotlighted in industrial and life fields due to a size small enough to carry while supporting various user functions. Presently, mobile terminals for integrally supporting various user functions are widely used. Such mobile terminals provide a screen corresponding to a user function through a display unit while supporting the user function. Accordingly, the user uses content through a screen according to operation of a corresponding function while using a specific user function.

Various display device technology is applied to a display unit of the above-described mobile terminal. For example, a technology of an Organic Light Emitting Diode (OLED) and a Thin Film Transistor-Liquid Crystal Display (TFT-LCD) is applied to a display unit of a mobile terminal according to the related art. Of these technologies, the OLED technology has excellent reactivity and a self light emitting function and thus a terminal can be produced in a small size. TFT-LCD technology requires a separate backlight unit and displays an image by enabling an LCD to selectively transmit light of the backlight unit. The above-described technologies are applied to several mobile terminals in consideration of various purposes and productivity.

A display unit of the mobile terminal displays an image by radiating light of predetermined luminance. Accordingly, in an environment in which an external light source of luminance larger than that applied to the display unit is provided, visibility of the display unit is deteriorated. In order to address this issue, research for enhancing a luminance performance of a Light Emitting Diode (LED) constituting a backlight unit or a transmission characteristic of a Liquid Crystal Display (LCD) has been performed. However, in an external environment in which sunlight is provided, the display unit is unable to effectively display content even if the display unit displays an image with maximum luminance. In a luminance environment of tens of thousands of luxes, such as that provided by sunlight, it is difficult to recognize a screen that is output to the display unit with only a light source provided by a backlight unit according to the related art. In order to address this issue, research for remarkably enhancing brightness of the display unit is ongoing, but a method of continuously enhancing brightness of the display unit is not preferable from a viewpoint of use of a mobile terminal, particularly from a viewpoint of battery use and thus there is a need to address this issue. When brightness of the display unit is enhanced, battery life is reduced significantly due to the extra power consumption, and thus in view of an entire use of mobile terminal, enhancing only the brightness of the display unit may not be preferable.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or provide at least the advantages described below. Accordingly, an aspect of the present invention is to provide a display device having enhanced visibility and a mobile terminal including the same that can appropriately recognize a screen of a display unit even under an environment in which a specific external light source such as sunlight is provided by enabling to adjust visibility in a specific environment of a mobile terminal according to a disposition of the terminal.

In accordance with an aspect of the present invention, a display device is provided. The device includes a liquid crystal display panel for displaying a predetermined image by selectively transmitting incident light, a backlight unit for providing light for driving the liquid crystal display panel, a diffraction sheet disposed between the liquid crystal display panel and the backlight unit for diffracting light from an external light source passing through the liquid crystal display panel and for reapplying the light toward a front surface direction from a rear surface of the liquid crystal display panel.

In accordance with another aspect of the present invention, a mobile terminal is provided. The terminal includes a display device for supporting a screen output according to terminal operation, and a controller for controlling an screen output of the display device, wherein the display device includes a liquid crystal display panel for displaying a predetermined image by selectively transmitting incident light, a backlight unit for providing light for driving the liquid crystal display panel, and a diffraction sheet disposed between the liquid crystal display panel and the backlight unit to diffract light from an external light source passing through the liquid crystal display panel and for reapplying the light toward a front surface direction from a rear surface of the liquid crystal display panel.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is an exploded perspective view illustrating a display device according to an exemplary embodiment of the present invention;

FIG. 2 is a diagram illustrating an optical characteristic of a diffraction sheet of FIG. 1 according to an exemplary embodiment of the present invention;

FIG. 3 is a diagram illustrating an example of a tilt operation of a mobile terminal according to an exemplary embodiment of the present invention;

FIG. 4 is a diagram illustrating another example of a tilt operation of a mobile terminal according to an exemplary embodiment of the present invention; and

FIG. 5 is a block diagram illustrating a configuration of a mobile terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

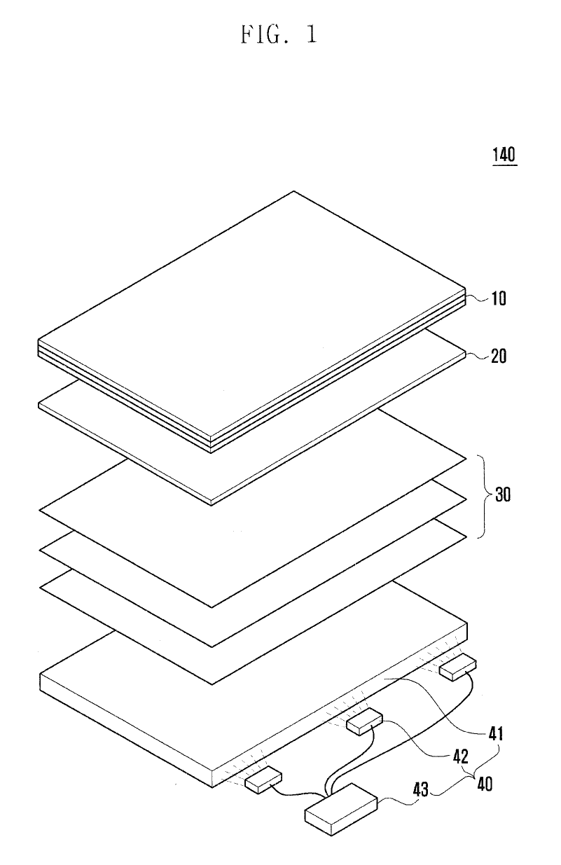

FIG. 1 is an exploded perspective view illustrating a display device according to an exemplary embodiment of the present invention.

Referring to FIG. 1, a display device 140 includes a Liquid Crystal Display (LCD) panel 10, a diffraction sheet 20, an optical sheet 30, and a backlight unit 40. The optical sheet 30 may be omitted according to a designer's intention, may be provided integrally with a light guide plate included in another element, for example the backlight unit 40, or may be provided integrally with a lower portion of the LCD panel 10. Accordingly, the display device 140 may be applied to a configuration in which the optical sheet 30 is omitted.

The display device 140 enables light generated in the backlight unit 40 to project in a front surface direction from a rear surface of the LCD panel 10 through the optical sheet 30 and the diffraction sheet 20. Light supplied to the LCD panel 10 is selectively transmitted according to the control of the LCD panel 10, thereby displaying an image. As the diffraction sheet 20 is disposed at a rear surface of the LCD panel 10, the display device 140 diffracts external light, having transmitted the LCD panel 10 to radiate the external light to a front surface direction of the LCD panel 10. The diffraction sheet 20 diffracts only light applied to a specific angle among light, having transmitted the LCD panel 10. Accordingly, when the display device 140 is inclined at a predetermined angle relative to a light incident angle of an external light source, the display device 140 processes the external light source as reflected light and uses this reflected light as a display light source, thereby maximizing visibility.

The LCD panel 10 displays a predetermined image by controlling light radiated from the backlight unit 40 to be selectively transmitted. The LCD panel 10 includes an upper substrate, a lower substrate, and a liquid crystal layer. In the lower substrate, Thin Film Transistors (TFT) are disposed in a matrix shape, and a pixel electrode is disposed at each TFT. A common electrode corresponding to a pixel electrode of the lower substrate is disposed, and a color filter layer is formed at the upper substrate. The liquid crystal layer is made of an electric anisotropic material. As the liquid crystal layer is disposed between the pixel electrode and the common electrode, a molecule arrangement changes due to a current flowing between the pixel electrode and the common electrode and thus light transmittance is changed. As a result, when power is supplied to a specific pixel electrode, a characteristic of liquid crystal disposed on the pixel electrode is changed and thus light transmitted from the backlight unit is radiated to the color filter layer. Accordingly, as the color filter layer emits light, a specific image is displayed. For this, the LCD panel 10 includes a gate driver and a data driver for controlling the TFT and includes a controller for transferring a signal to the gate driver and the data driver. In the foregoing description, a structure in which a common electrode and a color filter layer are disposed at an upper substrate is described, but exemplary embodiments of the present invention are not limited thereto. In the LCD panel 10 according to an exemplary embodiment of the present invention, a common electrode may be formed on a lower substrate. In addition, in order to enhance visibility, the LCD panel 10 may further include a black matrix.

When light is radiated by external sun light, the LCD panel 10 transmits some of the external light source. The external light source, having passed through the LCD panel 10, is transferred to the diffraction sheet 20 disposed at a lower part of the LCD panel 10.

The diffraction sheet 20 is disposed between the LCD panel 10 and the backlight unit 40 to diffract an external light source having passed through the LCD panel 10. The diffraction sheet 20 transmits light radiated from the backlight unit 40 to radiate the light to the LCD panel 10. In order to have a specific pattern, the diffraction sheet 20 is provided using laser patterning, nano material patterning, etching patterning using a photosensitive material, and printing patterning using inkjet. In order to transmit light radiated from the backlight unit 40, the diffraction sheet 20 may be made of a transparent material, for example PMMA, PET material, and in order to enhance transmission efficiency, the diffraction sheet 20 may be provided in a predetermined thickness or less. A thickness of the diffraction sheet 20 may be experimentally adjusted according to a pattern thickness or a pattern form and adjustment of transmittance of laser patterning.

The optical sheet 30 is disposed at a lower part of the diffraction sheet 20 and includes a plurality of sheets. For example, the optical sheet 30 may include at least one of a diffusion sheet for diffusing light radiated from the backlight unit 40 and a focus sheet for focusing the diffused light. Such an optical sheet 30 may be disposed at an upper portion of a light guide plate 41 of the backlight unit 40. The optical sheet 30 may be provided in an integral form at the light guide plate 41. In this case, the optical sheet 30 may be omitted. Further, the optical sheet 30 may be formed in one sheet and may be formed in a plurality of sheets, as described above. As shown in FIG. 1, the optical sheet 30 is disposed at a lower part of the diffraction sheet 20, but exemplary embodiments of the present invention are not limited thereto. The optical sheet 30 may be disposed at an upper part of the diffraction sheet 20. When the optical sheet 30 is disposed at an upper part of the optical sheet 30, the optical sheet 30 diffuses and focuses light radiated from the backlight unit 40 and passing through the diffraction sheet 20, as well as an external light source diffracted at the diffraction sheet 20, to enable the light and the external light source to be applied to a backward direction of the LCD panel 10. When the optical sheet 30 is disposed at a lower part of the optical sheet 30, the optical sheet 30 diffuses and focuses light radiated from the backlight unit 40 to transmit the light to the diffraction sheet 20. A location of the optical sheet 30 may be adjusted according to a characteristic of the mobile terminal.

The backlight unit 40 generates and radiates light for displaying an image of the display device 140. The backlight unit 40 may be provided in various forms according to a form of the display device 140. The backlight unit 40 includes the light guide plate 41, a plurality of LEDs 42 for radiating light to the light guide plate 41, and a power supply device 43 for supplying power to the LED 42.

The light guide plate 41 guides to radiate light radiated from the LED 42 toward the LCD panel 10. The light guide plate 41 is provided with a width corresponding to the LCD panel 10. In the light guide plate 41, a surface in which the optical sheet 30 is disposed is formed in a predetermined pattern for diffusion of light. Although not shown, the light guide plate 41 has different thicknesses of an area adjacent to the LED 42 and an opposite area thereof to radiate light radiated from the LED 42 toward the LCD panel 10. For example, in the light guide plate 41, a thickness of an area adjacent to the LED 42 is formed relatively greater than that of an opposite area thereof, and as advancing to the opposite area, a thickness of the area gradually reduces. Accordingly, when light radiated from the LED 42 collides with a bottom surface of the light guide plate 41, the light is radiated toward the LCD panel 10.

The LED 42 generates light using power supplied from the power supply device 43. The generated light is applied to a side portion of an adjacent light guide plate 41. The LED 42 is formed as a white light source and generates light of high luminance. In order to uniformly radiate light to an entire side portion of the light guide plate 41, a plurality of LEDs 42 are provided, as shown in FIG. 1.

The power supply device 43 supplies power to the LED 42. The power supply device 43 controls power supply and interception of power supply to the LED 42 according to the control from an external control system for driving the display device 140. In order to supply power to each LED 42, the power supply device 43 includes a power supply line connected to the each LED 42.

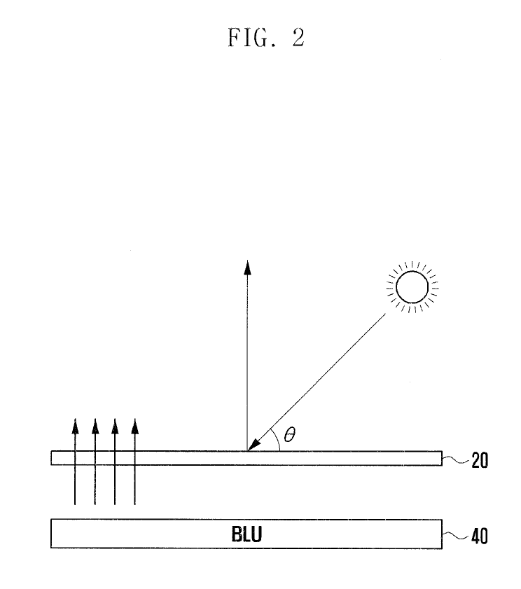

FIG. 2 is a diagram illustrating an optical characteristic of the diffraction sheet 20 of FIG. 1 according to an exemplary embodiment of the present invention.

Referring to FIG. 2, the diffraction sheet 20 is disposed at an upper part of the backlight unit 40 to perform a function of transmitting light radiated from the backlight unit 40. The diffraction sheet 20 provides a pattern that causes light emitted from the light guide plate 41 of the backlight unit 40 to proceed straight in a direction of the LCD panel 10. The pattern may be embodied using various patterning methods such as laser patterning, nano material patterning, etching patterning using a photosensitive material, and printing patterning using inkjet. A pattern for transmitting light from the backlight unit 40 may be provided in at least one of a front surface and a rear surface of the diffraction sheet 20, particularly, at a rear surface. Accordingly, the diffraction sheet 20 may include a rear surface pattern for transmitting an internal light source, having occurred in the backlight unit 40. Further, various patterns may be processed to be overlapped at one surface of the diffraction sheet 20, for example at least one of a front surface or a rear surface of the diffraction sheet 20.

A pattern may be formed in an internal space of the diffraction sheet 20 as well as a specific surface of the diffraction sheet 20. A pattern may be internally formed in an intermediate layer of a front surface and a rear surface of the diffraction sheet 20. The diffraction sheet 20 may have at least one of a surface in which a pattern for diffracting an external light source is provided and a surface in which a pattern for transmitting an internal light source is provided and at least one surface in which a pattern that supports at least one of diffraction of an external light source and transmission of an internal light source is provided, and at least one of space between a front surface and a rear surface. Accordingly, it should be understood that the diffraction sheet 20 has a configuration to provide at least one pattern that can diffract an applied external light source and reapply the external light source in a direction of the LCD panel 10 as well as one pattern formed at a specific surface.

When an external light source applied from the outside is applied to a predetermined angle at a front surface, the diffraction sheet 20 diffracts the external light source to be reapplied in a direction of the LCD panel 10. In this case, in order to maximize visibility, an incident angle of an external light source in which the diffraction sheet 20 diffracts is fixed within a predetermined range. In order to reapply an external light source having a predetermined incident angle in a direction of the LCD panel 10, the diffraction sheet 20 may include a predetermined pattern. The pattern may be formed in at least one of a front surface and a rear surface of the diffraction sheet 20. Particularly, the pattern may be formed at a front surface of the diffraction sheet 20. Accordingly, the diffraction sheet 20 may include a front surface pattern for diffraction of an external light source.

When an external light source is applied to an angle other than a predetermined incident angle, the diffraction sheet 20 having the above-described configuration does not perform diffraction or performs low diffraction. When an external light source is applied at a predetermined incident angle, the diffraction sheet 20 maximizes diffraction and diffracts an external light source to be reapplied in a direction of the LCD panel 10. Accordingly, a terminal using the display device 140 o changes a tilt of the display device 140 in an environment in which sunlight is radiated at a predetermined angle, thereby maximizing diffraction of present applied sunlight. As a result, the mobile terminal 100 changes a tilt of the display device 140 according to a situation and thus determines a time at which visibility is maximized, and easily determines information displayed in the display device 140 by maintaining a corresponding situation.

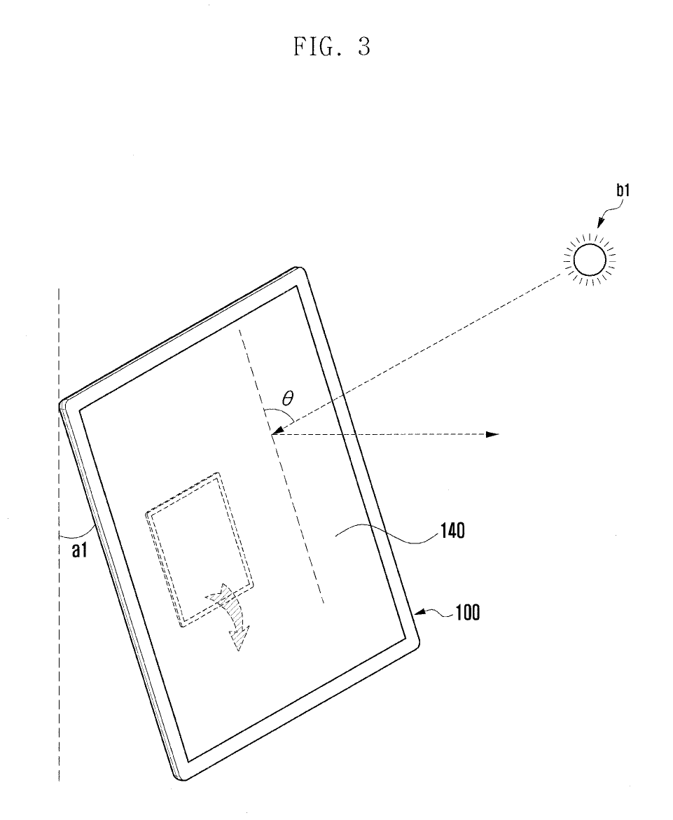

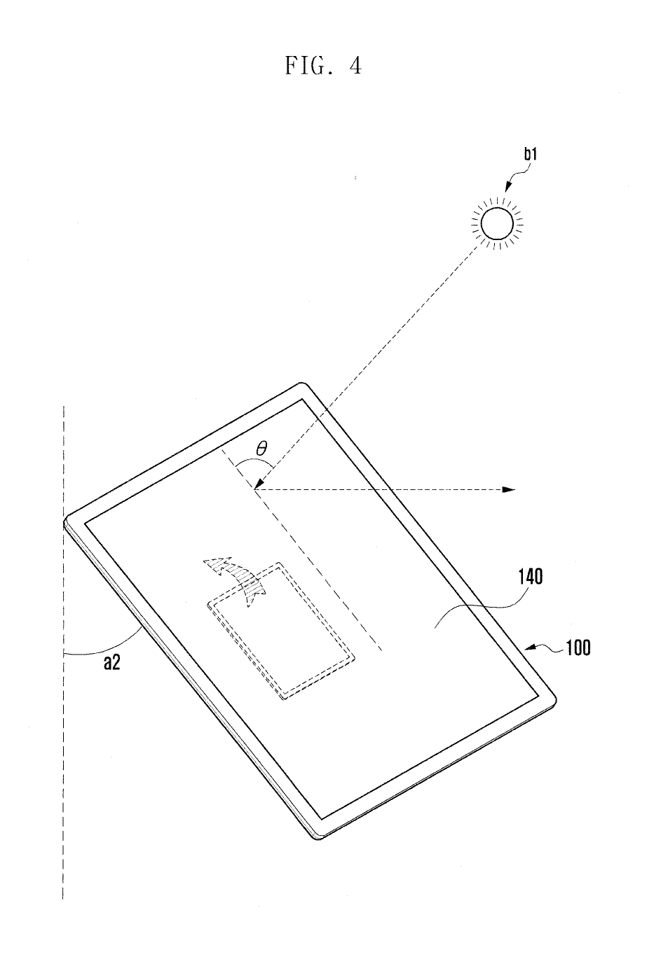

FIGS. 3 and 4 are diagrams illustrating an example of a tilt operation of a mobile terminal according to an exemplary embodiment of the present invention.

Referring to FIG. 3, when sunlight (or other external light source of the mobile terminal 100) is present at a first altitude b1, the mobile terminal 100 is controlled to have a first angle a1 based on a perpendicular line extended from the ground and to maintain a tilt state. In this case, sunlight radiated from the Sun of the first altitude b1 is radiated with a fixed incident angle θ relative to a surface of the display device 140 of the mobile terminal 100. A first tilt angle a1 of the mobile terminal 100 is an angle in which sun light is applied to the display device 140 with a fixed incident angle θ. The first angle a1 is obtained according to a user control operation while the user holds the terminal.

When sunlight is radiated to the surface of the display device 140 with the fixed incident angle θ, the sunlight passes through the LCD panel 10 and arrives at the diffraction sheet 20 disposed at a lower part of the LCD panel 10. The sunlight, having arrived at the diffraction sheet 20, is diffracted by the diffraction sheet 20, is again applied in a rear surface direction of the LCD panel 10, and thus performs a function as a light source for displaying an image of the LCD panel 10.

When sunlight (or other external light source) is located at a second altitude b2, the mobile terminal 100 may be disposed with a tilt of a second angle a2 based on a direction perpendicular to the ground. The second angle a2 may be an angle in which sunlight radiated from the Sun of the second altitude b2 is radiated with a fixed incident angle θ for the display device 140. The user may control the mobile terminal 100 to have the second angle a2, and when the mobile terminal 100 is disposed at the second angle a2, sunlight is radiated to the LCD panel 10 with a fixed incident angle θ. At least a portion of sunlight radiated to the LCD panel 10 with the fixed incident angle θ advances while passing through the LCD panel 10 and finally arrives at the diffraction sheet 20. The diffraction sheet 20 diffracts the transmitted sun light to radiate the sunlight to a front surface direction of the LCD panel 10 from a rear surface. Accordingly, when the mobile terminal 100 is disposed at a predetermined angle by the user, the mobile terminal 100 uses sunlight as an external light source, thereby maximizing light for driving the LCD panel 10. Accordingly, when the mobile terminal 100 is disposed at a predetermined angle even under an external environment such as sunlight, visibility may be maximized, and thus the user determines an image output to the display device 140.

In the foregoing description, sunlight is described as an exemplary external light source, but the present invention is not limited thereto. The external light source may be, for example, a general lighting lamp, and light radiated from the lighting lamp is applied to and is reflected from the LCD panel 10 with the same method as that of sunlight to provide an enhancement effect of visibility.

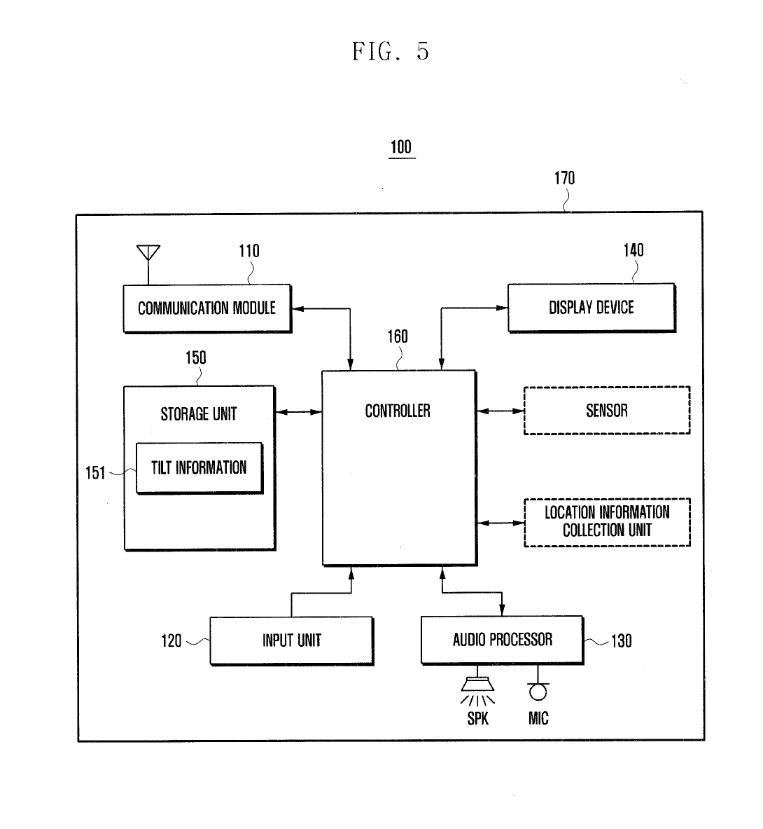

FIG. 5 is a block diagram illustrating a configuration of the mobile terminal 100 according to an exemplary embodiment of the present invention.

Referring to FIG. 5, the mobile terminal 100 includes a communication module 110, input unit 120, audio processor 130, display device 140, storage unit 150, controller 160, and case 170. The mobile terminal 100 may further include a location information collection unit for collecting location information of the terminal and a sensor for detecting a rotation operation or a tilt state of the terminal.

The communication module 110 performs a communication function of the mobile terminal 100. The communication module 110 may be omitted according to whether a communication function of the mobile terminal 100 is provided. The communication module 110 may be omitted when the mobile terminal 100 does not provide a communication function. The communication module 110 forms a communication channel with another mobile terminal or a specific server device and transmits and receives a signal with another mobile terminal and a server device. The communication module 110 supports at least one of various communication methods according to a characteristic of the mobile terminal 100. For example, the communication module 110 may be formed with a module according to at least one communication method of various methods such as a mobile communication module, short range communication module, and wired communication module. A screen according to operation of the communication module 110 is output through the display device 140. For example, an outgoing call screen, incoming call screen, and server connection screen according to operation of the communication module 110 may be output through the display device 140. An operation screen of the communication module 110 output to the display device 140 maximizes visibility of according to whether an external light source is provided and a tilt angle of the mobile terminal 100 and thus enables to easily perform a screen search for operating a corresponding function even under a predetermined external luminance environment.

The input unit 120 generates various input signals necessary for operation of the mobile terminal 100. The input unit 120 may be provided in a form of a specific key such as a button key, home key, and side key and may be embodied in a key map according to a support method of the mobile terminal 100. For example, when the mobile terminal 100 supports a full touch screen, the input unit 120 may be embodied in a form of a key map output to the display device 140. When the input unit 120 is embodied by the display device 140, visibility may be different according to a tilt angle of the display device 140.

The audio processor 130 includes a Speaker (SPK) for outputting an audio signal stored at the mobile terminal 100 or received from the outside and a Microphone (MIC) for collecting an audio signal for communication or recording. The audio processor 130 outputs an audio signal for supporting various terminal functions of the mobile terminal 100. When the mobile terminal 100 is inclined at a predetermined angle, the audio processor 130 outputs an effect sound corresponding to a tilt. In order to detect a tilt, the mobile terminal 100 may further include an acceleration sensor. When an illumination sensor included in the mobile terminal 100 detects a predetermined luminance or more and the display device 140 is activated, the audio processor 130 may provide a guide sound for guiding the mobile terminal 100 to have a previously defined incident angle for sunlight. When the mobile terminal 100 is disposed at a tilt of the predetermined angle, the audio processor 130 may output a notification sound for an optimal state of visibility. For this, the mobile terminal 100 stores a database of a tilt angle of the mobile terminal 100 according to an altitude of the Sun at various locations basis in the storage unit 150.

In the display device 140, the diffraction sheet 20 is disposed between the LCD panel 10 and the backlight unit 40 to diffract light, having transmitted the LCD panel 10. Accordingly, when the display device 140 is disposed at a predetermined angle for an external light source, visibility is maximized. The display device 140 outputs various screens according to operation of the mobile terminal 100. For example, the mobile terminal 100 may output various screens such as an operation screen of the communication module 110, file search screen, file reproduction screen, and file search screen. In addition, the display device 140 displays an image of a tilt operation of the terminal according to a present location of the terminal. For example, the display device 140 may output a guide image of a disposition state of the mobile terminal 100, as shown in FIGS. 3 and 4. In this case, the display device 140 outputs a disposition state guide image as a translucent image, thereby reducing inconvenience of recognition due to overlapping of the guide image in an information search process.

The storage unit 150 stores an operation system and various application programs necessary for operation of the mobile terminal 100. The storage unit 150 stores various data according to use of the mobile terminal 100. The storage unit 150 stores various tilt information 151 of a tilt state on a time and a location basis of the mobile terminal 100. The stored tilt information 151 may be referred by the controller 160.

The case 170 houses various elements of the mobile terminal 100, and fixes an outer edge of the display device 140. The case 170 may be variously changed according to a design of the mobile terminal 100. The case 170 may be disposed to expose various sensors, for example an illumination sensor for supporting a function of the mobile terminal 100, and may have an acceleration sensor therein.

The controller 160 supports various signal processing and signal transfer for supporting a function of the mobile terminal 100. The controller 160 activates a specific terminal function according to an input signal generated in the input unit 120 or previously set predetermined information. The controller 160 collects present location information of the mobile terminal 100 and collects altitude information of sun based on present location and time information. When sunlight is applied to the display device 140 based on the collected altitude information of the Sun, the controller 160 controls to output information that guides to incline the mobile terminal 100 to have a previously defined incident angle. When light collected by an illumination sensor is greater than or equal to a predetermined luminance, the controller 160 controls to output information for collection of location information and time information and guide of a tilt. In order to output information for guiding a tilt, the controller 160 may refer to information collected by an acceleration sensor, a gyro sensor, or a terrestrial magnetic sensor and control to output an indication image such as an arrow or a guide sound so that the mobile terminal 100 has a tilt of a previously defined predetermined angle.

The above-described function may be supported according to a user setting. When the user turns off the function, the controller 160 may omit separate sensor information collection and notification information output. With respect to the tilt information 151 of the mobile terminal 100, a radiation angle of sunlight may be changed according to an altitude of the Sun on a time and a location basis of the mobile terminal 100. Accordingly, a radiation angle of sunlight is experimentally collected based on the altitude information of the Sun on a time and a location basis, and the tilt information 151 may be set an incident angle in which sunlight is applied to the display device 140 to be a previously defined predetermined angle based on the collected radiation angle. The previously defined incident angle of sunlight may be adjusted according to a characteristic of the disposed diffraction sheet 20.

As described above, the mobile terminal 100 having the display device 140 including the diffraction sheet 20 uses an external light source as a light source of the LCD panel 10 in a specific environment, thereby maximizing visibility. Accordingly, the user can view information displayed in the display device 140 with only a simple operation of inclining the mobile terminal 100 according to a current environment. In addition, when visibility is improved through operation of inclining the mobile terminal 100, the user may unnecessarily repeat a tilt operation within a predetermined range of the mobile terminal 100. In order to address such an issue, in the present invention, by providing predetermined guide information through an image or audio output corresponding to tilt information, while enabling the user not to perform unnecessary terminal operation control, visibility can be optimized.

The mobile terminal 100 including the display device 140 may further include various addition modules according to a providing form thereof The mobile terminal 100 may further include constituent elements that are not described in the foregoing description, such as a short range communication module for short range communication, interface for transmitting and receiving data by a wired communication method or a wireless communication method of the terminal 100, Internet communication module for performing an Internet function by communicating with an Internet network, and digital broadcasting module for performing a digital broadcasting reception and reproduction function. Further, in the mobile terminal 100, specific constituent elements may be omitted from the above-described configuration or replaced with other constituent elements according to a providing form thereof This will be easily understood to a person of ordinary skill in the art.

The mobile terminal 100 including the display device 140 according to an exemplary embodiment of the present invention may include information communication devices, multimedia devices, and application devices thereof such as mobile communication terminals operating based on communication protocols corresponding to various communication systems and a Portable Multimedia Player (PMP), digital broadcasting player, Personal Digital Assistant (PDA), music player (e.g., an MP3 player), portable game terminal, smart phone, and notebook computer, and hand-held PC.

As described above, in a display device according to exemplary embodiments of the present invention and a mobile terminal including the display device, visibility can be enhanced in a specific environment even without supplying additional power to the display device.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A display device, the display device comprising:
a liquid crystal display panel for displaying a predetermined image by selectively transmitting incident light;
a backlight unit for providing light for driving the liquid crystal display panel; and
a diffraction sheet disposed between the liquid crystal display panel and the backlight unit for diffracting the light from an external light source passing through the liquid crystal display panel, and for reapplying the light toward a front surface direction from a rear surface of the liquid crystal display panel.

2. The display device of claim 1, wherein the diffraction sheet transmits an internal light source generated in the backlight unit, diffracts the external light source passing through the liquid crystal display panel and applied at a predetermined angle, and reapplies the external light source toward a front surface direction of the liquid crystal display panel.

3. The display device of claim 2, wherein the diffraction sheet comprises at least one of a space between a front surface and a rear surface and at least one surface in which a pattern that supports at least one of diffraction of the external light source and transmission of the internal light source is provided.

4. The display device of claim 3, wherein the pattern is provided in a transparent material through at least one patterning method of laser patterning, nano material patterning, etching patterning using a photosensitive material, and printing patterning using inkjet.

5. The display device of claim 1, further comprising:
an optical sheet disposed between the diffraction sheet and the backlight unit.

6. The display device of claim 1, further comprising:
an optical sheet disposed between the liquid crystal display panel and the diffraction sheet.

7. The display device of claim 1, wherein the external light source is sunlight.

8. A mobile terminal, the mobile terminal comprising:
a display device for supporting a screen output according to terminal operation; and
a controller for controlling a screen output of the display device,
wherein the display device comprises:
a liquid crystal display panel for displaying a predetermined image by selectively transmitting incident light;
a backlight unit for providing light for driving the liquid crystal display panel; and
a diffraction sheet disposed between the liquid crystal display panel and the backlight unit to diffract the light from an external light source passing through the liquid crystal display panel, and to reapply the light toward a front surface direction from a rear surface of the liquid crystal display panel.

9. The mobile terminal of claim 8, wherein the diffraction sheet transmits an internal light source generated in the backlight unit, diffracts the external light source that is passing through the liquid crystal display panel and applied at a predetermined angle, and reapplies the external light source toward a front surface direction of the liquid crystal display panel.

10. The mobile terminal of claim 8, wherein the diffraction sheet comprises at least one of a space between a front surface and a rear surface and at least one surface in which a pattern that supports at least one of diffraction of the external light source and transmission of the internal light source is provided.

11. The mobile terminal of claim 10, wherein the pattern is provided in a transparent material through laser patterning, nano material patterning, etching patterning using a photosensitive material, and printing patterning using inkjet.

12. The mobile terminal of claim 8, further comprising:
a location information collection unit for collecting location information of the mobile terminal; and
a sensor for sensing a tilt of the display device.

13. The mobile terminal of claim 12, further comprising:
a storage unit for storing tilt information that defines the tilt of the display device on a location and a time basis in order to apply the external light source according to an altitude of the external light source with a predetermined incident angle.

14. The mobile terminal of claim 13, wherein the controller determines a present location and time of the display device, determines the tilt information of the display device corresponding to information of the present location and time, and controls to output information for guiding a tilt of the display device to be an angle defined in the tilt information.

15. The mobile terminal of claim 8, further comprising:
an optical sheet disposed between the diffraction sheet and the backlight unit.

16. The mobile terminal of claim 8, further comprising:
an optical sheet disposed between the liquid crystal display panel and the diffraction sheet.

17. The mobile terminal of claim 8, wherein the external light source is sunlight.
